(19) United States
(12) Patent Application Publication
(10) Pub. No.: US 2004/0166483 A1
(43) Pub. Date: Aug. 26, 2004

(54) Computer-based self-motivated guide learning system and method

(76) Inventors: Sayling Wen, Taipei (TW); Zechary Chang, Taipei (TW); Pinky Ma, Beijing (CN)

Correspondence Address: BIRCH STEWART KOLASCH & BIRCH, PO BOX 747, FALLS CHURCH, VA, 22040-0747, US

(21) Appl. No.: 10/372,841

(22) Filed: Feb. 26, 2003

(51) Int. Cl. G09B 7/00

(52) U.S. Cl. 434/323

(57) ABSTRACT

A computer-based self-motivates guide learning system and the corresponding method are disclosed. During the learning process, an encourage module stores guide learning initiation conditions set by the user and guide learning stop conditions. Such conditions are used to keep the user motivated to learn. The disclosed system includes a learning module, a secondary learning module, an encourage module, and a main control module. The disclosed method includes the steps of: getting user's settings, reading a learning level, executing the learning process, and recording the learning level, storing the current learning level and stopping the learning process after the guide learning initialization conditions are satisfied, executing the encourage process and recording the execution level, and switching back to the learning process once the guide learning stop conditions are satisfied.

### BACKGROUND OF THE INVENTION

1. Field of Invention

The invention relates to a learning system and method. In particular, the invention pertains to a computer-based self-motivated guide learning system and method which, according to the user's settings, provides a guide learning process during the learning process.

2. Related Art

The learner is a developing and practicing subject in a learning activity. In general, the learner has to go through a painful experience to achieve a specific knowledge or skill standard required by the environment, especially when the learner is not self-motivated. If there is no strong constraining force from outside (e.g. teachers and parents), such pain may easily make the learner to give up learning. However, if the learner can be more self-motivated, then the learning process can become more interesting and joyful for the learner. Moreover, the learning effect will be much better. Therefore, how to encourage and effectively keep the learner's will so that he or she can finish a complete course is a long-term subject under study by educators.

With the advance in computer technology, some computer-based learning systems have been developed to keep learner motivated in learning. However, the operation of their encourage modules are kind of fixed. In other words, they cannot interfere the learning process at a proper time. On the contrary, such systems often provide learners with good excuses to avoid learning. Also, not every encourage module is applicable to all learners.

### SUMMARY OF THE INVENTION

In view of the foregoing, the invention provides a computer-based self-motivated guide learning system and method. An objective of the invention is to embed a guide learning procedure during the learning process, so that the leaner can be kept motivated for learning.

To achieve the above objective, the disclosed system includes: a learning module, a secondary module, an encourage module, and a main control module. The disclosed method include the steps of: getting user's settings, reading a learning level, executing the learning process, and recording the learning level, storing the current learning level and stopping the learning process after the guide learning initialization conditions are satisfied, executing the encourage process and recording the execution level, and switching back to the learning process once the guide learning stop conditions are satisfied.

### BRIEF DESCRIPTION OF THE DRAWINGS

The invention will become more fully understood from the detailed description given hereinbelow illustration only, and thus are not limitative of the present invention, and wherein:

FIG. 1 is a structural diagram of the disclosed computer-based self-motivated guide learning system;

FIG. 2 is a flow chart of the disclosed computer-based self-motivated guide learning method;

FIG. 3 is a schematic view of the setting interface of the disclosed encourage module;

FIG. 4 is a schematic view of the disclosed learning process; and

FIG. 5 is a schematic view of the disclosed guide learning process.

### DETAILED DESCRIPTION OF THE INVENTION

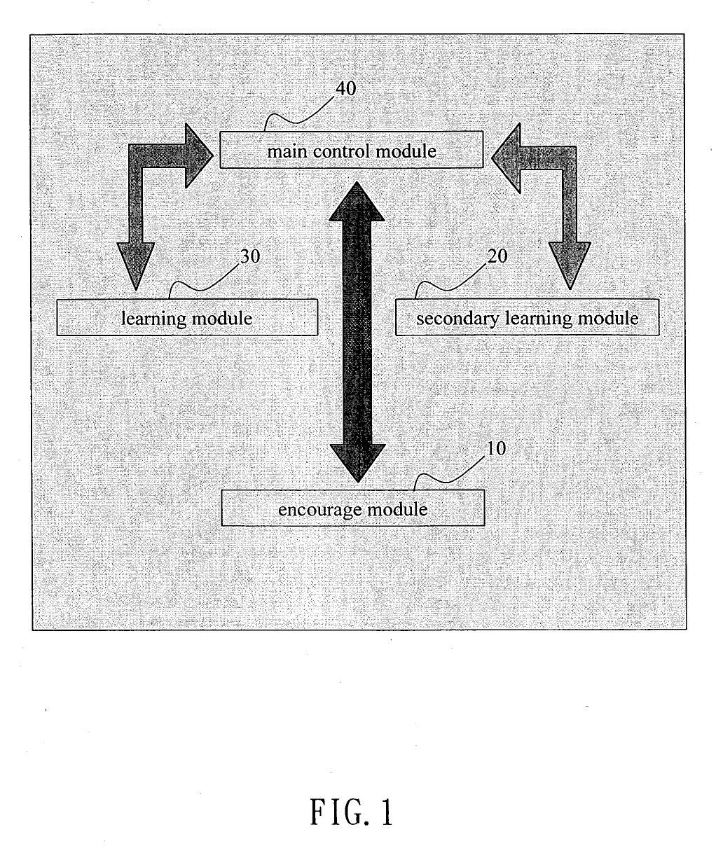

Please refer to FIG. 1 for a drawing of the disclosed computer-based self-motivated guide learning system. It has a leanring module 10, a secondary module 20, an encourage module 30, and a main control module 40.

(1) The encourage module 10 allows the user to set guide learning process initialization conditions (b), guide learning process stop conditions (c) or (d) (including inserted units and the number of inserted pages) and the guide learning process generating method (a). It also generates an encourage process for the user to set up a target for himself or herself according to the learning habits.

(2) The secondary learning module 20 enables the user to perform the computer-aided guide learning process. The module is not limited to any particular form. It can be any entertainment software, such as game or story software, running on a computer platform.

(3) The learning module 30 provides the user with a computer-aided learning process. The module is not limited to any particular form either. It can be computer-based software with the learning function, such as language learning software.

(4) The main control module 40 sets up a schedule for the learning process and the guide learning process according to the guide learning process initialization conditions (b), the guide learning process stop conditions (c) or (d), and the guide learning process type (a). The guide learning process type (a) includes at least game or story software such that te learning attention can be temporarily deviated. Uring the switches of the processes, the main control module 40 sends out execution and interrupt commands to control the learning module 30 and the second learning module 20 according to the guide learning process initialization conditions (b), the guide learning process stop conditions (c) or (d), and the guide learning process type (a). This is to achieve the goal of switching between the learning process and the secondary learning process. Moreover, it is hoped that the user can set up an encourage process that can continuously enhance his or her learning will according to the learning habits.

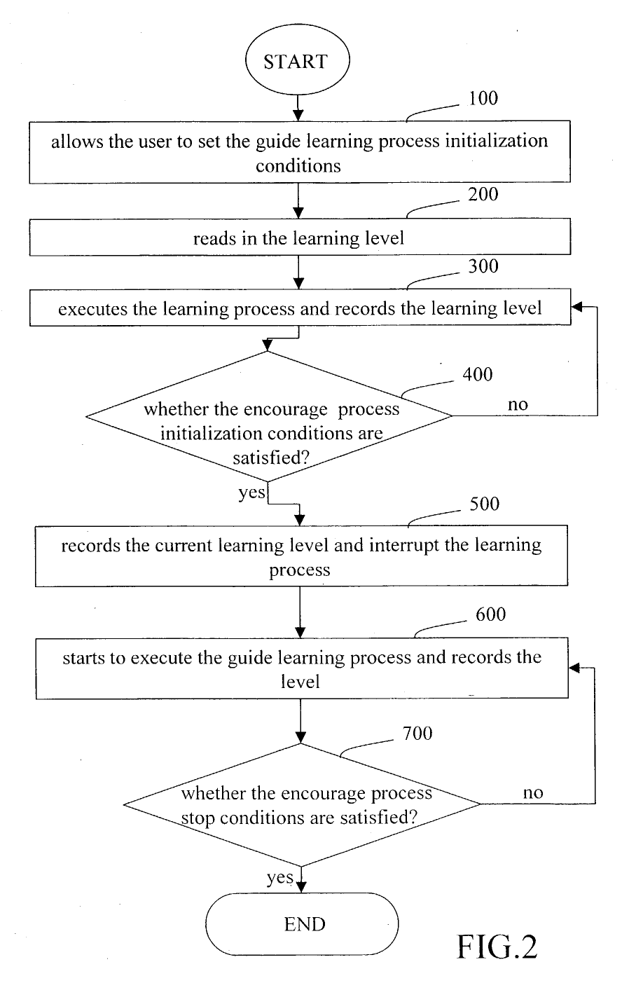

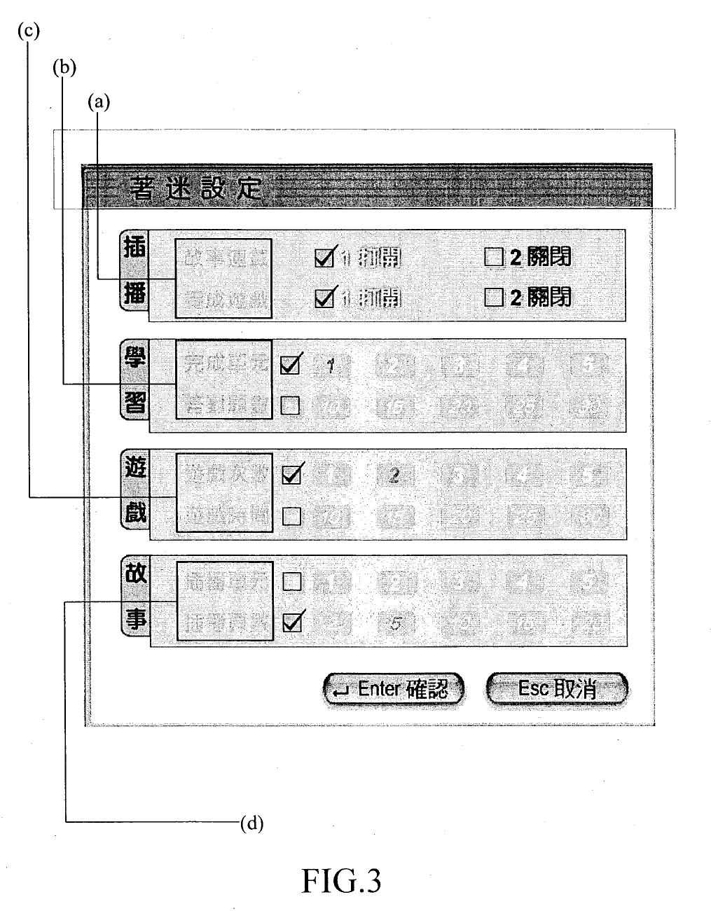

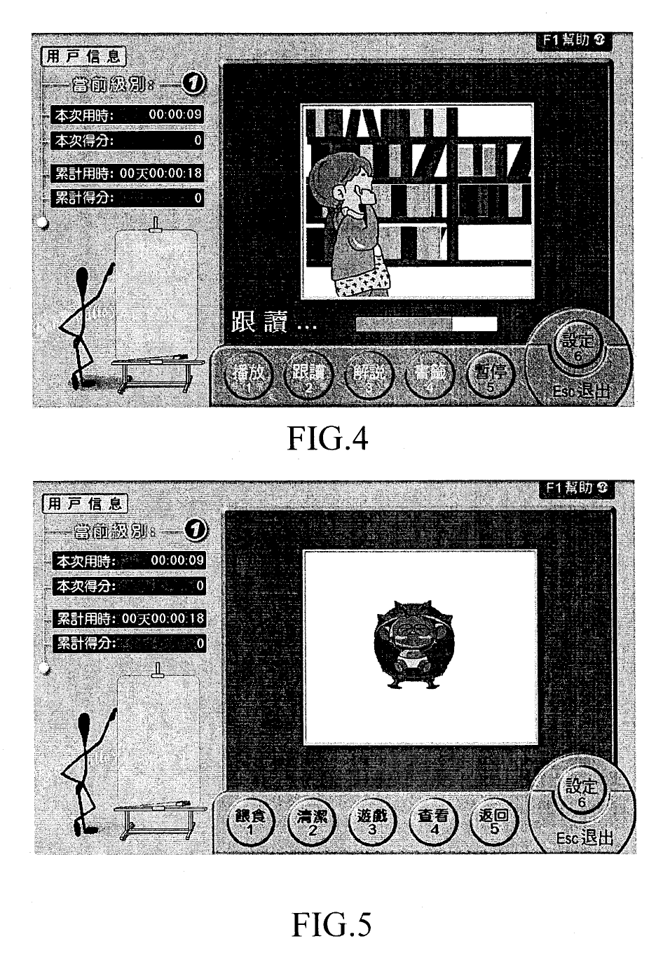

We use FIG. 2 to demonstrate the disclosed learning method. Through the setting interface of the encourage module 10 (as in FIG. 3), the system first allows the user to set the guide learning process initialization conditions (b), the guide learning process stop conditions (c) or (d), and the guide learning type (a) (step 100). Afterwards, the user start learning software in the system, and the learning module 30 reads in the learning level (step 200). This is the level stored in the learning module 30 from the previous learning process. The system executes the learning process and records the learning level (step 300), as shown in FIG. 4. The main control module 40 takes the level stored in the learning module 30 and encourage process initialization conditions (b), such as the number of completed units and the number of correct answers, to determine whether the conditions (b) are satisfied (steo 400). If the conditions (b) are not satisfied, then the system keeps running the learning process and recording the learning level (step 200) until the the conditions (b) are satisfied. Once the conditions (b) are satisfied, the system records the current learning level and interrupt the learning process (step 500). The main control module 40 sends out a storage command to the learning module to record the current learning level. An interrupt command is sent to the learning module to stop the learning process. The system then starts to execute the guide learning process and records the level (step 600), as shown in FIG. 5. The main control module 40 detects whether the encourage process stop conditions (c) or (d) are satisfied (step 700) according to the level stored in the secondary learning module 20, the encourage process stop conditions (c) or (d), such as the number of times and the time for games. If the conditions (c) or (d) are not satisfied, the system keeps running the encourage process and recording the execution level (step 500) until the encourage process stop conditions (c) or (d) are satisfied. If the learning process is to be continued, the system goes back to step 100 to go through the procedure described above.

### EFFECTS OF THE INVENTION

The disclosed computer-based self-motivated guide learning system and method cook up a learning process that is most suitable for the learner according to his or her settings. The learning tiredness and attention are timely diverted so that the learner can be kept motivated all the time.

Certain variations would be apparent to those skilled in the art, which variations are considered within the spirit and scope of the claimed invention.

What is claimed is:

1. A computer-based self-motivated guide learning system comprising:
a learning module, which provides a learning process;
a secondary learning module, which provides a guide learning process;
an encourage module, which allows the user to set initialization conditions and stop conditions of a guide learning process and generates an encourage process; and
a main control module, which controls the learning process and the guide learning process according to the initialization conditions and the stop conditions, and controls the process execution by the learning module and the secondary learning process and storage and restoration of learning levels.

2. The system of claim 1, wherein the secondary learning module is selected from a group consisting of game and series story software.

3. The system of claim 1, wherein the initialization conditions of the guide learning process include at least the number of completed units and the number of correct answers.

4. The system of claim 1, wherein the stop conditions of the guide learning process include at least the times of a game and a game time.

5. The system of claim 1, wherein the stop conditions of the guide learning process include at least the number of inserted units and the number of inserted pages.

6. The system of claim 1, wherein the encourage module further allows a user to set the type of a guide learning process.

7. A computer-based self-motivated guide learning method for generating an encourage process according to user's settings, the method comprising the steps of:
allowing the user to perform settings;
reading a learning level;
executing a learning process and recording the current learning level;
satisfying the initialization conditions for a guide learning process;
storing the current learning level and interrupting the learning process;
executing the guide learning process and recording the execution level; and
satisfying the stop conditions for the guide learning process.

8. The method of claim 7, wherein the steps of executing a learning process and recording the current learning level and satisfying the initialization conditions of a guide learning process are repeated if the initialization conditions for the guide learning process are not satisfied.

9. The method of claim 7, wherein the steps of executing the guide learning process and recording the execution level and satisfying the stop conditions for the guide learning process are repeated if the stop conditions for the guide learning process are not satisfied.
